(19) United States
(12) Patent Application Publication
(10) Pub. No.: US 2016/0366572 A1
(43) Pub. Date: Dec. 15, 2016

(54) Text-a-Card Paperless Business Card

(71) Applicant: James Anthony Davis, Ellenton, FL (US)

(72) Inventor: James Anthony Davis, Ellenton, FL (US)

(21) Appl. No.: 15/042,088

(22) Filed: Feb. 11, 2016

Related U.S. Application Data
(60) Provisional application No. 62/176,192, filed on Feb. 12, 2015.

(51) Int. Cl. H04W 4/20; H04W 4/14

(52) U.S. Cl. CPC H04W 4/20; H04W 4/14

(57) ABSTRACT

This invention in all its claims is easy and convenient to use for the end user and intended to be transferred via wireless networks. It is not web based and does not require any web based downloads. The general idea and purpose of invention is provide end users the ability to quickly and conveniently put their actual graphically reformatted high definition paperless version of their business card in the palm of the hands of their prospects and customers anytime, anywhere even while speaking with them during a call on their Smartphone via wireless technology. This invention is guaranteed to consistently display sharp, crisp and large on all Smartphone displays. A graphically designed high definition reformatted paperless version of a card stock printed business card in the same vivid color, imagery and detail as a card stock printed business card.

### CROSS-REFERENCE TO RELATED APPLICATIONS

Benefit is being claimed of earlier-filed provisional application #62/176,192 Filing or 371(c) DATE Feb. 12, 2015 Confirmation No. 8012

Text-a-Card paperless business card, a graphically designed high definition reformatted paperless version of a card stock printed business card in the same vivid color, imagery and detail as a card stock printed business card that is intended to be texted (mms) via a wireless network from a Smartphone mobile device.

### BACKGROUND OF THE INVENTION

A common method of exchanging personal and/or business contact information from one person to another is through the exchange of physical printed business cards. But this practice usually requires both parties to be physically in the same place at the same time. In today's business environment there is an ever increasing use of Smartphone wireless technology as a form of a business communication tool. Business people may make their initial contact with a prospect by means of making or receiving a call on their Smartphone. Until now, if a business person wanted to give their business card to the person they were talking with they would have had to take a picture of their paper business card with their Smartphone and text it to the other person. The problem has been that the picture they may take will almost always be small, fuzzy, hard to read, substandard business logo color clarity and may have a glare. And because the paper business card original is a rectangle shape when a viewer looks at it holding their Smartphone vertically then horizontally the business card image flips and changes proportions in size. That causes a frustrating experience for the viewer as well as an unimpressive, unprofessional and possibly embarrassing attempt for the sender to give out his/her business card. That was then . . . this is now . . . that problem is solved. So, how can people put their actual business card (a reformatted paperless image in the same vivid color, sharp imagery and detail as their card stock printed business card) in the palm of the hand of the person they are speaking with during a call on their Smartphone? A person can now accomplished that simply by following their specific Smartphones mms messaging protocol in attaching their reformatted paperless image version of their actual business card to a text message and sending it right to the person while they're speaking with them. Seconds later the recipient receives the sender's business card and can open it to see a large square display of the business card on their Smartphone display in the same impressive quality as the sender's actual paper card version. The sender's professionally reformatted paperless version of their business card is saved to their Smartphone so they can retrieve and conveniently attach it to any text message anytime. Problem solved.

It needs to be stated that currently in the world of ‘non-paper’ business card technological alternatives, all alternative products are ‘web based’ and none to date have proven to be as effective and consistent as this invention regarding its being 100% functional, reliable, sendable and receivable on all Smartphones where mms messaging is available. This invention in all its claims is intended to be transferred via wireless networks. It is not web based and does not require any web based downloads.

It is with respect to these and other considerations that the present invention has been made.

### SUMMARY OF THE INVENTION

The existing technology regarding ‘non-paper’ business card alternatives are limited in functionality for the user in that they are all web based and almost all require the sender and recipient to download some kind of web based App in order to send or receive an the so called digital business card. Another problem that exists in the current marketplace is that almost the entire existing web based non-paper business card alternatives can only be sent or received by certain Smartphone devices because of the devices operating system. Example is some will not be received on a iPhone if it is sent from an Android device and vice versa. This is a serious limiting usability problem for end users since over 47% of the Smartphones in the USA are iPhone and over 47% are Android devices. The existing web based non-paper business card alternatives are complicated to learn and frustrating to use for the end user. Furthermore, because of limitations in technology, none of the existing web based non-paper business card alternatives can offer what this invention does regarding virtually exact representation of an original paper business cards vivid color, imagery and detail. It is obvious the existing web based non-paper business card industry has been, and is still, in a state of flux and uncertainty. All of the above mentioned problems have been addressed, researched and solved by this invention. This invention has been proven to be effective and consistent as being 100% functional, reliable, sendable and receivable on all Smartphones where mms service is available. This invention in all its claims is easy and convenient to use for the end user and intended to be transferred via wireless networks. It is not web based and does not require any web based downloads. The general idea and purpose of invention is to provide end users the ability to quickly and conveniently put their actual graphically reformatted paperless version of their business card in the palm of the hands of their prospects and customers anytime, anywhere even while speaking with them during a call on their Smartphone via wireless technology. This invention is guaranteed to consistently display sharp, crisp and large on all Smartphone displays.

### BRIEF DESCRIPTION OF DRAWINGS

FIG. 1 Illustrates how a Text-a-Card paperless wireless version of a business card looks.

FIG. 2 Illustrates how a Text-a-Card paperless wireless version of a business card displays on a typical Smartphone.

FIG. 3 Illustrates how a typical paper business card can display if a person takes a picture of their card stock business card.

### DETAILED DESCRIPTION OF INVENTION

This invention has been proven to be effective and consistent as being 100% functional, reliable, sendable and receivable and displays as intended on all Smartphones where mms messaging is available. This invention in all its claims is easy and convenient to use for the end user and intended to be transferred via wireless networks. It is not web based and does not require any web based downloads. The general idea and purpose of invention is provide end users the ability to quickly and conveniently put their actual graphically reformatted paperless version of their business card in the palm of the hands of their prospects and customers anytime, anywhere even while speaking with them during a call on their Smartphone via wireless technology. This invention is guaranteed to consistently display sharp, crisp and large on all Smartphone displays.

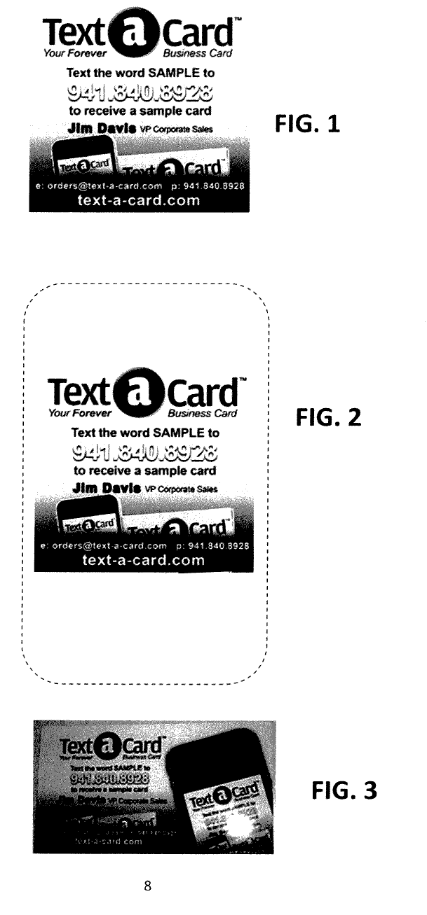

A common method of exchanging personal and/or business contact information from one person to another is through the exchange of physical printed business cards but this practice usually requires both parties to be physically in the same place at the same time. In today's business environment there is an ever increasing use of Smartphone wireless technology as a form of a business communication tool. Business people may make their initial contact with a prospect by means of making or receiving a call on their Smartphone. Until now, if a business person wanted to give their business card to the person they were talking with they would have had to take a picture of their paper business card with their Smartphone and text it to the other person. The problem has been that the picture they may take will almost always be small, fuzzy, hard to read, substandard business logo color clarity and may have a glare (FIG. 3). And because the paper business card original is a rectangle shape when a viewer looks at it holding their Smartphone vertically then horizontally the business card image flips and changes proportions in size. That causes a frustrating experience for the viewer as well as an unimpressive, unprofessional and possibly embarrassing attempt fur the sender to give out his/her business card. That was then this is now . . . that problem is solved. So, how can people put their actual business card, a reformatted paperless image in the same vivid color, sharp imagery and detail as their card stock printed business card in the palm of the hand of the person their speaking with during a call on their Smartphone? A person can now accomplished that simply by following their specific Smartphones mms messaging protocol in attaching their reformatted square shaped (with dimensions of 500×500 to 1,000×1,000 pixels per inch and sharp resolution of 300 dpi and a file size from 350 kb to 600 kb) paperless image version of their actual business card (FIG. 1) to a text message and sending it directly to the person while they're speaking with them. Seconds later the recipient receives the sender's business card and can open it to see a large square display of the business card on their Smartphone display (FIG. 2) in the same impressive quality as the sender's actual paper card version. The sender's professionally reformatted square paperless version of their business card is saved to their Smartphone so they can retrieve and conveniently attach it to any text message anytime. Problem solved.

It needs to be stated that currently in the world of ‘non-paper’ business card technological alternatives, all alternative products are ‘web based’ and none to date have proven to be as effective and consistent as this invention regarding it's being 100% functional, reliable, sendable and receivable on all Smartphones where mms service is available. This invention in all its claims is intended to be transferred via wireless networks. It is not web based and does not require any web based downloads.

1. This invention has been proven to be effective and consistent regarding its being 100% functional, reliable, sendable and receivable and displays as intended on all Smartphones where mms messaging is available.

2. This invention in all its claims is easy and convenient to use for the end user and intended to be transferred via wireless networks. It is not web based and does not require any web based downloads. The general idea and purpose of invention is to provide end users the ability to quickly and conveniently put their actual graphically reformatted paperless version of their business card in the palm of the hands of their prospects and customers anytime, anywhere even while speaking with them during a call on their Smartphone via wireless technology. This invention is guaranteed to consistently display sharp, crisp and large on all Smartphone displays.

3. The invention provides virtually exact representation of an original paper business cards vivid color, imagery and detail.

4. A graphically designed high definition reformatted paperless version of a card stock printed business card in the same vivid color, imagery and detail as a card stock printed business card that is intended to be texted (mms) via a wireless network from a Smartphone mobile device to another Smartphone mobile device.
